(19) United States
(12) Patent Application Publication
(10) Pub. No.: US 2016/0189212 A1
(43) Pub. Date: Jun. 30, 2016

(54) METHOD AND SYSTEM FOR RECOMMENDING ONE OR MORE ITEMS FOR SKIPPING ADVERTISEMENTS

(71) Applicant: Sanjeev Madhava Rao, Manhattan Beach, CA (US)

(72) Inventor: Sanjeev Madhava Rao, Manhattan Beach, CA (US)

(21) Appl. No.: 14/587,230

(22) Filed: Dec. 31, 2014

(51) Int. Cl. G06Q 30/02

(52) U.S. Cl. CPC G06Q 30/0255; G06Q 30/0257; G06Q 30/0269; G06Q 30/0249; G06Q 30/0275

(57) ABSTRACT

The present disclosure provides a method and system for recommending one or more items to a user for skipping one or more advertisements at a corresponding one or more advertisement slots in a content. The method includes fetching a first pre-determined set of attributes and recommending the one or more items to the user for skipping the one or more advertisements at the corresponding one or more advertisement slots in the content. The one or more items includes one or more probabilistic amount for skipping one or more percentage of advertisements in the corresponding one or more advertisement slots, one or more time for viewing the content, one or more channels for viewing the content and one or more type of devices for viewing the content.

### TECHNICAL FIELD

The present invention relates to the field of advertising and, in particular, relates to recommending one or more items for skipping advertisements in content.

### BACKGROUND

Advertising is a fast growing industry which functions on a fact of survival of the fittest. The increase in number of consumers accessing internet nowadays is a result of the advent of new portable devices such as smart phones, tablets, personal computers and the like. With an increasing percentage of the consumer demographics opting to explore online services, internet advertising is now a multi-billion dollar industry. Many publishers utilize the amount of people using the internet nowadays and have started displaying advertisements in both online and offline content seen by the users on one or more devices. The publishers display one or more types of advertisements to the users for generating revenue through advertisers.

Nowadays, more and more users have started to show a significant amount of interest in watching one or more advertisements. Further, the users want to watch the one or more advertisements as per their specific interests. Advertisements are displayed to the consumers through various formats such as video, audio, text and the like. However, the users get annoyed by encountering a number of advertisements. The users do not want to experience any interruption while watching the content. Moreover, the users want to skip maximum number of the advertisements in order to have a better viewing experience. This is a big concern for the publishers for whom the generation of revenue depends on receiving a positive response regarding interaction of the users with the advertisements. The publishers are focusing on capturing the attention of users who are adamant towards advertising despite the user bypassing the advertisements. Moreover, the publishers are trying to maximize monetization of their content through various advertisement networks.

Some of the present methods and systems allow the users to skip the advertisements by simply clicking on the skip advertisement button. This is the easiest way of skipping the advertisements. Further, some systems provide the user with an option of blocking the advertisements through various advertisement blocking softwares when the user is viewing the advertisements online. In addition, some current methods allow the users to skip the advertisements by paying a sum of money to the publisher.

The existing methods and systems for viewing advertisement free content are not quite feasible and result in wastage of money for the users. Further, the existing methods and systems known in the art do not provision the users to have an idea of how much budget they should provide for skipping maximum number of advertisements. Moreover, the existing methods and systems do not recommend the users with a type of device for viewing the content such that the user has a better viewing experience than viewing the content on another type of device. In addition, the existing methods and systems provide recommendation of content to the users. One such system known in the art providing the content recommendation takes into account nature of device through which the user requests for the content. This type of content recommendation technique assumes that the user utilizes the same device for watching the content. However, the users do not always use the same device for watching the content. Going further, the existing methods and systems do not provide the users with suitable time for watching the content such that the user can skip maximum number of the advertisements at the provided time. Moreover, existing methods and systems do not provide the users with options of viewing the content on one or more channels such that to have a better content viewing experience.

In the light of the above stated discussion, there is a need for a method and system that overcomes the above stated disadvantages of the present methods.

### SUMMARY

In an aspect of the present disclosure, a computer-implemented method for recommending one or more items to a user for skipping one or more advertisements at a corresponding one or more advertisement slots in content is provided. The computer-implemented method includes fetching, with a processor, a first pre-determined set of attributes and recommending, with the processor, one or more items to the user for skipping the one or more advertisements at the corresponding one or more advertisement slots in the content. The first pre-determined set of attributes includes a first set of parameters corresponding to the user and one or more pre-defined factors. The one or more pre-defined factors are based on a pre-defined criterion. The one or more items includes one or more probabilistic amount for skipping one or more percentage of advertisements at the corresponding one or more advertisement slots, one or more time for viewing the content, one or more channels for viewing the content and one or more type of devices for viewing the content. The one or more probabilistic amount is calculated based on the first set of parameters and the pre-defined criterion. The recommendation of the one or more probabilistic amount to the user is based on calculation of a real time probable amount provided the user had viewed the one or more advertisements in the content.

In an embodiment of the present disclosure, the first set of parameters includes a profile corresponding to the user. The profile includes at least one of gender of the user, interaction of the user with the one or more advertisements and one or more choices of the user corresponding to type of the one or more advertisements.

In an embodiment of the present disclosure, the pre-defined criterion is based on at least one of an estimated amount for the one or more advertisement slots and a bid winning history corresponding to the user. In another embodiment of the present disclosure, the pre-defined criterion is based on at least one of type of the content, an advertisement skipping history corresponding to the user and one or more previous advertisement skipping budgets corresponding to the user. In an embodiment of the present disclosure, the one or more previous advertisement skipping budgets are set by the user for skipping the one or more advertisements.

In an embodiment of the present disclosure, the calculation of the real time probable amount is based on a real time bidding process.

In an another embodiment of the present disclosure, the computer-implemented method further includes maintaining, with the processor, a database of the first set of parameters, the advertisement skipping history, the one or more previous advertisement skipping budgets, the one or more probabilistic amount, the one or more time, the one or more channels and the one or more type of devices.

In another aspect of the present disclosure, a computer system is provided. The computer system includes a non-transitory computer readable medium storing a computer readable program; the computer readable program when executed on a computer causes the computer to perform steps. The steps include fetching a first pre-determined set of attributes and recommending one or more items to a user for skipping one or more advertisements at corresponding one or more advertisement slots in a content. The first pre-determined set of attributes includes a first set of parameters corresponding to the user and one or more pre-defined factors. The one or more pre-defined factors are based on a pre-defined criterion. The one or more items includes one or more probabilistic amount for skipping one or more percentage of advertisements at the corresponding one or more advertisement slots, one or more time for viewing the content, one or more channels for viewing the content and one or more type of devices for viewing the content. The one or more probabilistic amount is calculated based on the first set of parameters and the pre-defined criterion. The recommendation of the one or more probabilistic amount to the user is based on a calculation of a real time probable amount provided the user had viewed the one or more advertisements in the content.

In an embodiment of the present disclosure, the first set of parameters includes a profile corresponding to the user. The profile includes at least one of gender of the user, interaction of the user with the one or more advertisements and one or more choices of the user corresponding to type of the one or more advertisements.

In an embodiment of the present disclosure, the pre-defined criterion is based on at least one of an estimated amount for the one or more advertisement slots and a bid winning history corresponding to the user. In another embodiment of the present disclosure, the pre-defined criterion is based on at least one of type of the content, an advertisement skipping history corresponding to the user and one or more previous advertisement skipping budgets corresponding to the user. In an embodiment of the present disclosure, the one or more previous advertisement skipping budgets are set by the user for skipping the one or more advertisements.

In an embodiment of the present disclosure, the computer readable program when executed on the computer causes the computer to perform the step of maintaining a database of the first set of parameters, the advertisement skipping history, the one or more previous advertisement skipping budgets, the one or more probabilistic amount, the one or more time, the one or more channels and the one or more type of devices.

In yet another aspect of the present disclosure, a system for recommending one or more items to a user for skipping one or more advertisements at a corresponding one or more advertisement slots in content is provided. The system includes a fetching module in a processor configured to fetch a first pre-determined set of attributes and a recommendation engine in the processor and communicatively coupled to the fetching module, the recommendation engine configured to recommend the one or more items to the user for skipping the one or more advertisements at the corresponding one or more advertisement slots in the content. The first pre-determined set of attributes includes a first set of parameters corresponding to the user and one or more pre-defined factors. The one or more pre-defined factors are based on a pre-defined criterion. The one or more items includes one or more probabilistic amount for skipping one or more percentage of advertisements atthe corresponding one or more advertisement slots, one or more time for viewing the content, one or more channels for viewing the content and one or more type of devices for viewing the content. The one or more probabilistic amount is calculated based on the first set of parameters and the pre-defined criterion. The recommendation of the one or more probabilistic amount to the user is based on calculation of a real time probable amount provided the user had viewed the one or more advertisements in the content.

In an embodiment of the present disclosure, the first set of parameters includes a profile corresponding to the user. The profile includes at least one of gender of the user, interaction of the user with the one or more advertisements and one or more choices of the user corresponding to type of the one or more advertisements.

In an embodiment of the present disclosure, the pre-defined criterion is based on at least one of an estimated amount for the one or more advertisement slots and a bid winning history corresponding to the user. In another embodiment of the present disclosure, the pre-defined criterion is based on at least one of type of the content, an advertisement skipping history corresponding to the user and one or more previous advertisement skipping budgets corresponding to the user. In an embodiment of the present disclosure, the one or more previous advertisement skipping budgets are set by the user for skipping the one or more advertisements.

In an embodiment of the present disclosure, the calculation of the real time probable amount is based on a real time bidding process.

In an embodiment of the present disclosure, the system further includes a database configured to maintain the database of the first set of parameters, the advertisement skipping history, the one or more previous advertisement skipping budgets, the one or more probabilistic amount, the one or more time, the one or more channels and the one or more type of devices.

### BRIEF DESCRIPTION OF THE FIGURES

Having thus described the invention in general terms, reference will now be made to the accompanying drawings, which are not necessarily drawn to scale, and wherein:

FIG. 1 illustrates a general overview of a system for recommending one or more items, in accordance with various embodiments of the present disclosure;

FIG. 2A, FIG. 2B and FIG. 2C illustrate a system for recommending the one or more items, in accordance with various embodiments of the present disclosure;

FIG. 3 illustrates a block diagram of a communication device, in accordance with various embodiments of the present disclosure; and

FIG. 4 illustrates a flowchart for recommending the one or more items, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

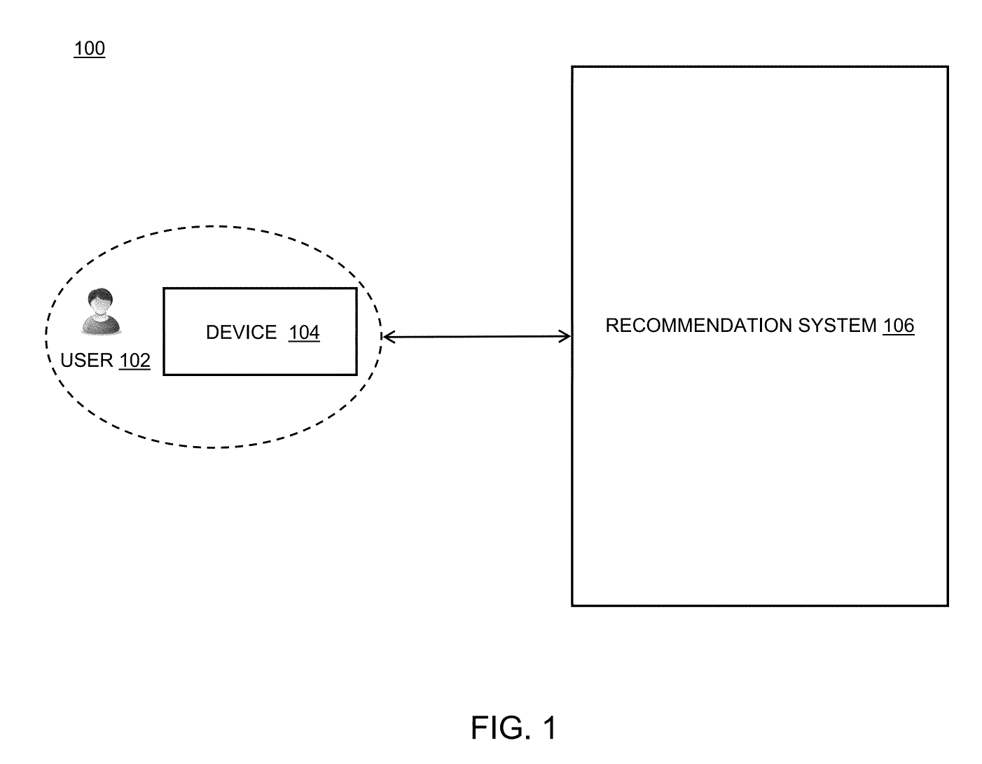

FIG. 1 illustrates a general overview of a system 100 for recommending one or more items for skipping one or more advertisements at a corresponding one or more advertisement slots in a content, in accordance with various embodiments of the present disclosure. The system 100 includes a device 104 associated with a user 102 and a recommendation system106. The user 102 may be any individual or a person accessing the device 104. Examples of the device 104 include but may not be limited to laptops, mobile phones, computers, tablets, a television set, a personal digital assistant(PDA) and Roku. The device 104 may be connected to an internet broadband system, a local area network, a wide area network, a metropolitan area network, a virtual private network, a personal area network or any other network known in the art for providing access to the user 102.

The user 102 watches the content of one or more contents on the device 104. The content may be an online content or offline content, live or delayed, video on demand, packaged as streaming and the like. Further, the content may take a form of mobile applications and games providing display of the one or more advertisements. Moreover, the content include but may not be limited to an audio content, a video content, a flash content, text content and HTML content. Further, the user 102 views the content on the device 104 according to his/her specific interests. The user 102 may be interested in watching videos related to sports, movies or any recreational activity, listening to songs, visiting social networking sites, watching news on television, playing games on mobile phone or any other content according to a choice of the user 102. In an embodiment of the present disclosure, the user 102 watches the content on a channel of one or more channels according to his/her interests. For example, a user X watches a movie on his/ her laptop on a website (say www.cbs.com), a user Y watches a video of a popular TV show on his/her tablet on a website (say www.hulu.com) and a user Z watches highlights of a cricket match on Roku on an online channel(say www.starsports.com).

The user 102 encounters the one or more advertisements at different advertisement time slots while watching the content on the device 104. Further, one or more publishers provide the one or more advertisements to the user 102. Examples of the one or more publishers include but may not be limited to youtube, dailymotion, facebook, news channels, movie channels,and mobile applications. The one or more advertisements include audio advertisements, video advertisements, textual advertisements, flash advertisements, rich media advertisements (For example, HTML advertisement) and the like. Further, an advertisement from the one or more advertisements may be in a form of a short survey poll for promotion. Continuing with the above stated example, the user X watches an advertisement of a newly released movie and a shoe brand while watching the movie on his/her laptop on www.cbs.com, the user Y watches an advertisement of a new TV show and a smart phone while watching the TV show on his/her tablet on www.hulu.com and the user Z watches an advertisement of an apparel brand and a car brand while watching the highlights of the cricket match on Roku on www.starsports.com.

In addition, the recommendation system 106 recommends the one or more items to the user 102 for skipping the one or more advertisements at the corresponding one or more advertisement slots in the content. In an embodiment of the present disclosure, the recommendation system 106 provides one or more options to the user 102 for providing a better content viewing experience. In another embodiment of the present disclosure, the recommendation system 106 recommends the one or more items in real time to the user 102.

Extending the above stated example, the user X watches the advertisement of the newly released movie in an advertisement slot Si and the advertisement of the shoe brand in the advertisement slot S2, the user Y watches the advertisement of the new TV show in an advertisement slot T1 and the advertisement of the smart phone in an advertisement slot T2 and the user Z watches the advertisement of the apparel brand in an advertisement slot Ul and the advertisement of the car brand in an advertisement slot U2.

It may be noted that in FIG. 1, the user 102 is associated with the device 104 for viewing the content; however those skilled in the art would appreciate that more users are associated with more devices for viewing the content. For example, a user A, a user B and a user C are associated with a device D1, a device D2 and a device D3.

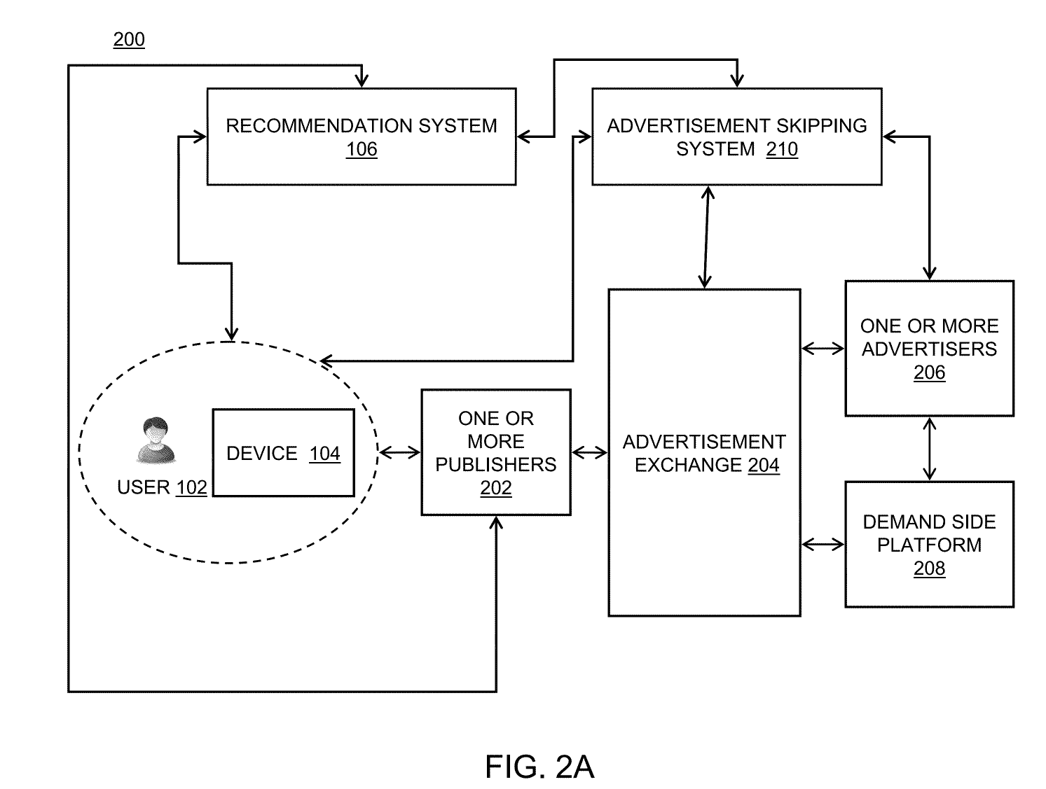

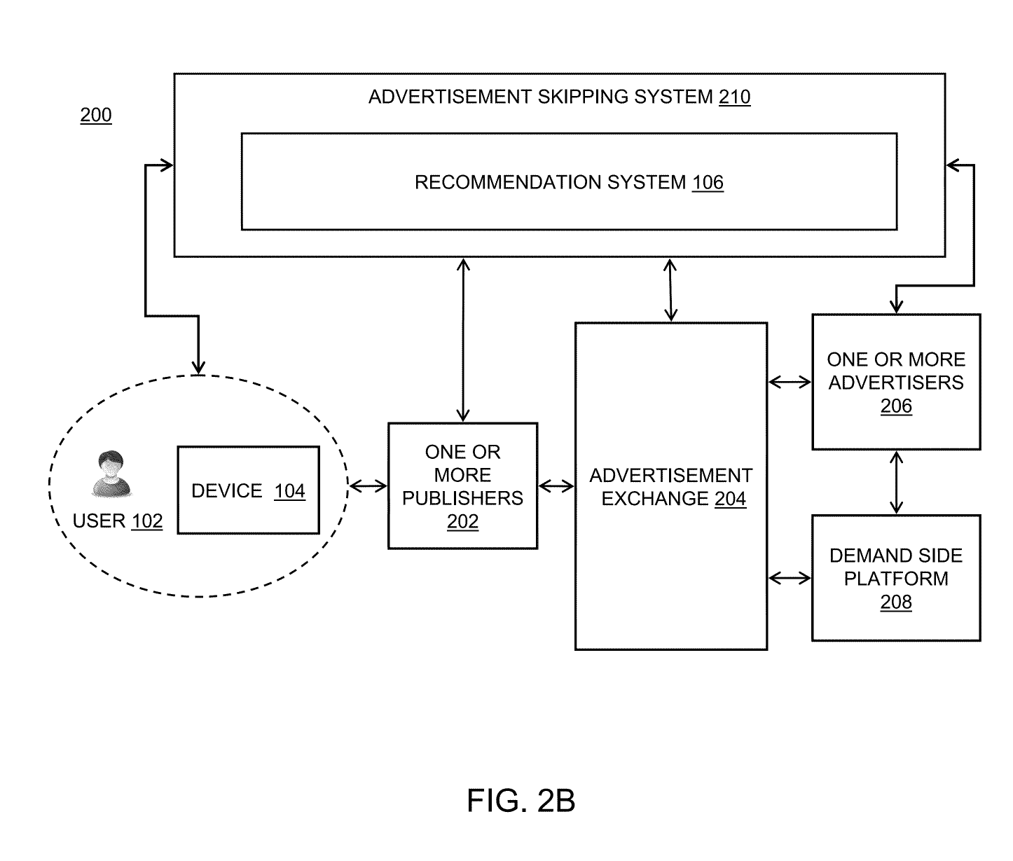

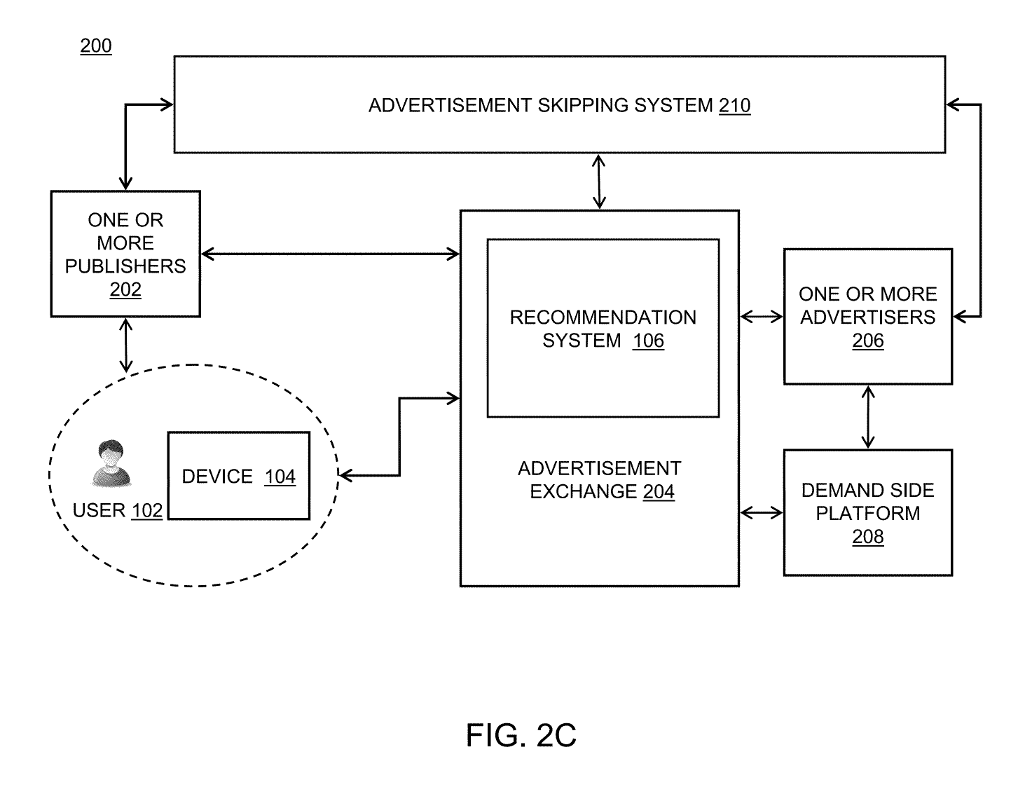

FIG. 2A illustrates a system 200 for recommending the one or more items to the user 102 for skipping the one or more advertisements at the corresponding one or more advertisement slots in the content, in accordance with various embodiments of the present disclosure. The content maybe viewed by the user 102on the device 104. It may be noted that to explain the system elements of FIG. 2A, references will be made to the system elements of FIG. 1.

The system 200 depicts an interconnection of the recommendation system 106 with the device 104 associated with the user 102, one or more publishers 202, an advertisement exchange 204, one or more advertisers 206, a demand side platform 208 and an advertisement skipping system 210. The user 102 accesses the content on the device 104. Each of the one or more publishers 202 provide or display online and offline content, live or delayed content, video on demand and the like to the user 102. Examples of the one or more publishers 202 include websites (facebook, google, yahoo and the like), mobile applications, television channels and the like.

The one or more publishers 202 advertise products, services or businesses to the users 102 for generating revenue. In an embodiment of the present disclosure, the one or more publishers 202 are associated with the one or more advertisers 206 through the advertisement exchange 204. The one or more advertisers 206 provide advertisements to the one or more publishers 202. In another embodiment of the present disclosure, the one or more publishers 202 are associated with the one or more advertisers 206 through the advertisement exchange 204.

The one or more advertisers 206 may be one or more brands, one or more manufacturers, one or more retailers, one or more service providers, one or more government agencies and the like. Further, the one or more advertisers 206 provide the one or more advertisements to convey information to the user 102 and other one or more users, to generate a response from the user 102 and the other one or more users, to prompt the user 102 and the other one or more users in making a purchase or to ask the user 102 and the other one or more users to participate in any online or offline event.

The advertisement exchange 204 provides a platform for the one or more publishers 202 and the one or more advertisers 206 for buying and selling of advertisement inventory. Examples of the advertisement exchange 204 include but may not be limited to Microsoft AdECN, Yahoo Right Media, DoubleClick, AppNexus, and OpenX. In an embodiment of the present disclosure, the one or more publishers 202 and the one or more advertisers 206 deal directly without the intervention of the advertisement exchange 204.

The one or more publishers 202 provide the one or more advertisement slots to the advertisement exchange 204. The demand side platform 208 decides the one or more advertisement slots the one or more advertisers 206 should buy. The price of the one or more advertisement slots is decided through a real time bidding process. The real time bidding process takes place in milliseconds before, after or during the content. The one or more publishers 202 provide their advertisement inventory to the advertisement exchange 204 which holds the real time bidding process. The demand side platform 208 bids on behalf of the one or more advertisers 206 for winning the one or more advertisement slots. Value of a bid placed by the demand side platform 208 for the one or more advertisers 206 is determined by the buying parameters set by the one or more advertisers 206. The real time bidding process terminates many advertisers from the one or more advertisers206 as an advertiser with a highest bid is declared the winner of a particular advertisement slot from the one or more advertisement slots and allowed to show his or her advertisement in the particular advertisement slot on a publisher of the one or more publishers 202.

Further, the user 102 is associated with the advertisement skipping system 210. In an embodiment of the present disclosure, the user 102 is associated with the advertisement skipping system 210 through the device 104. The advertisement skipping system 210 enables the skipping of the one or more advertisements in the corresponding one or more advertisement slots in the content viewed by the user 102. The user 102 is registered on the advertisement skipping system 210 and is authorized for skipping the one or more advertisements. Moreover, the one or more advertisements are provided based on the real time bidding process. In an embodiment of the present disclosure, the advertisement skipping system 210 skips the one or more advertisements in real time. In another embodiment of the present disclosure, the advertisement skipping system 106 enables the user 102 to skip maximum number of the one or more advertisements.

Going further, the advertisement skipping system 210 is associated with the recommendation system 106 for recommending the one or more items to the user for skipping the one or more advertisements at the corresponding one or more advertisement slots in the content. In an embodiment of the present disclosure, the recommendation system 106 provides the one or more options to the user 102 such as to skip the maximum number of the one or more advertisements in the corresponding one or more advertisement slots in the content.

The user 102 accesses the content on the device 104. In addition, the recommendation system 106 fetches a first pre-determined set of attributes. The first pre-determined set of attributes includes a first set of parameters corresponding to the user 102 and one or more pre-defined factors. Further, the one or more pre-defined factors are based on a pre-defined criterion. The first set of parameters includes a profile corresponding to the user 102. In an embodiment of the present disclosure, the profile depicts information corresponding to the user 102. In another embodiment of the present disclosure, the profile includes at least one of gender of the user 102, interaction of the user 102 with the one or more advertisements and one or more choices of the user 102 corresponding to type of the one or more advertisements. In yet another embodiment of the present disclosure, the advertisement skipping system 210 stores the profile of the user 102.

In addition, the pre-defined criterion is based on at least one of type of the content accessed by the user 102, an advertisement skipping history corresponding to the user 102 and one or more previous advertisement skipping budgets corresponding to the user 102. Furthermore, the one or more previous advertisement skipping budgets depict one or more amounts provided by the user 102 to the advertisement skipping system 210 for skipping the one or more advertisements in the corresponding one or more advertisement slots. In an embodiment of the present disclosure, the one or more amounts are set by the user 102 through an account on the advertisement skipping system 210.

In another embodiment of the present disclosure, the advertisement skipping system 210 stores the advertisement skipping history and the one or more previous advertisement skipping budgets corresponding to the user 102. In yet another embodiment of the present disclosure, the recommendation system 106 fetches one or more past inputs provided by the user 102 for skipping the one or more advertisements in the content. In yet another embodiment of the present disclosure, the recommendation system 106 fetches the first pre-determined set of attributes from a database maintained by the advertisement skipping system 210 corresponding to the user 102.

In an example, a user A provides a budget of 20$ every month for skipping the one or more advertisements, a user B provides a budget of 10$ for first two months and a budget of 15$ for next four months for skipping advertisements of the one or more advertisements and a user C provides a budget of 12$ for first month, 10 $ for second month and 30$ for next three months for skipping the one or more advertisements. The user A has skipped 80 percent of the one or more advertisements while watching 50 hours of content in last six months, the user B has skipped 60 percent of the one or more advertisements while watching 42 hours of content in the first two months and 50 percent of the one or more advertisements while watching 60 hours of content in the next four months and the user C has skipped 90 percent of the one or more advertisements while watching 70 hours of content in the first month, 70 percent while watching 30 hours of content in the second month and 80 percent while watching 65 hours of content in the next three months.

Going further, the recommendation system 106 recommends the one or more items to the user 102 for skipping the one or more advertisements in the corresponding one or more advertisement slots in the content. In an embodiment of the present disclosure, the recommendation system 106 recommends the one or more items to the user 102 for skipping optimum number of the one or more advertisements. The one or more items include one or more probabilistic amount for skipping one or more percentage of the one or more advertisements in the corresponding one or more advertisement slots in the content, one or more channels to view the content on, one or more type of devices to view content on and one or more time for viewing the content.

The one or more channels include but may not be limited to online channels (say www.hulu.com, www.cbs.com, www.starsports.com, www.youtube.com and the like) and offline channels(star world, headlines today, CNBC and the like). The one or more type of devices includes mobile, laptop, roku, desktop computer and the like.

Further, the one or more probabilistic amount corresponds to one or more advertisement skipping budgets provided to the user 102. In an embodiment of the present disclosure, the one or more probabilistic amount corresponds to a budget scope.

Moreover, the recommendation system 106 calculates the one or more probabilistic amount based on the fetched first pre-determined set of attributes. In an embodiment of the present disclosure, the recommendation system 106 calculates the one or more probabilistic amount based on the first set of parameters corresponding to the user 102 and the one or more pre-defined factors. In another embodiment of the present disclosure, the calculation of the one or more probabilistic amount is based on at least one of the profile corresponding to the user 102, the type of content accessed by the user 102, the advertisement skipping history corresponding to the user 102 and the one or more previous advertisement skipping budgets corresponding to the user 102.

Moreover, the recommendation system 106 recommends the one or more probabilistic amount based on a real time bidding amount corresponding to the one or more advertisements. In an embodiment of the present disclosure, the real time bidding amount corresponds to an amount the one or more advertisers 206 would have to pay to the one or more publishers 202 had the user 102 viewed the one or more advertisements.

In an another embodiment of the present disclosure, the recommendation system 106 calculates the one or more probabilistic amount for a new user (user 102) based on the estimated amount of the one or more advertisement slots and the bid winning history of the new user (user 102).

In another embodiment of the present disclosure, the recommendation system 106 utilizes the profile of the new user (user 102) and a mathematical model for calculating the one or more probabilistic amount for skipping the one or more percentage of the one or more advertisements in the corresponding one or more advertisement slots.

In yet another embodiment of the present disclosure, the recommendation system 106 calculates number of advertisement slots in the content accessed by the user 102.

Continuing with the above stated example, the user A accesses a video of a new movie on his/her laptop on www.youtube.com at 6 pm, the user B accesses a video of a cricket match highlights on his/her smart phone on star sports channel at 8 pm and the user C accesses a news on his/her television on headlines today news channel at 10 am. The video of the new movie includes advertisement slots s1, s2, s3 and s4, the video of the cricket match highlights includes advertisement slots t1, t2 and t3 and the news channel content includes advertisement slots u1, u2, u3, u4 and u5. The recommendation system 106 calculates the real time bidding amount for the advertisement slots in the content accessed by the user A, the user B and the user C. The real time bidding amount for the advertisement slot s1 is 0.03$, s2 is 0.04$, s3 is 0.11$ and s4 is 0.14$, the real time bidding amount for the advertisement slot t1 is 0.13$, t2 is 0.09$ and t3 is 0.02$ and the real time bidding amount for the advertisement slot u1 is 0.05$, u2 is 0.03$, u3 is 0.10$, u4 is 0.08$ and u5 is 0.12$.

In an embodiment of the present disclosure, the recommendation system 106 recommends the one or more probabilistic amount such that the user 102 skips maximum number of advertisements of the one or more advertisements in the content with a minimum amount of fees.

In addition, the recommendation system 106 recommends the one or more channels such that the user 102 watches the content on a channel of the one or more channels with a provision of skipping the maximum number of the advertisements of the one or more advertisements. In an embodiment of the present disclosure, the user 102 selects the channel of the one or more channels to skip maximum percentage of the one or more advertisements in the corresponding one or more advertisement slots in the content.

Further, the recommendation system 106 recommends the one or more type of devices such that the user 102 watches the content on a device of the one or more type of devices offering to skip the maximum percentage of the one or more advertisements in the corresponding one or more advertisement slots in the content.

Furthermore, the recommendation system 106 recommends the one or more time such that the user 102 skips the maximum percentage of the one or more advertisements at a recommended time. In an embodiment of the present disclosure, the recommendation system 106 recommends the one or more time such that the user 102 avoids wastage of the advertisement skipping budget.

In an embodiment of the present disclosure, the recommendation system 106 recommends one or more combination of the one or more items to the user 102. In another embodiment of the present disclosure, the recommendation system 106 recommends a subset of the one or more items to the user 102. For example, the recommendation system 106 recommends the one or more probabilistic amount and the one or more type of devices to a user K, the one or more probabilistic amount and the one or more channels to a user L and the one or more time, the one or more type of devices and the one or more channels to a user M.

Moreover, the recommendation system 106 recommends the one or more items to the user 102 such that to minimize a scoring function F1. In an embodiment of the present disclosure, the recommendation system 106 minimizes the scoring function F1 to maximize value and experience of the user 102.

The recommendation system 106 minimizes the scoring function F1 as described below:

F1=Func1(Cost|close to Budget Threshold when available without exceeding it, F0)

where

F0=Func2(Ad durations, # of pre-roll, # of mid-roll)

In an embodiment of the present disclosure, function Fund 1 and function Func2 may be linear or non-linear.

In another embodiment of the present disclosure, the recommendation system 106 minimizes the scoring function F1 where the advertisement skipping budget is not specified based on formula given below:

F1=(Cost*a0+c0)/(duration*a1+NumPreRollAds*a2+NumMidRollAds*a3+c1)

In yet another embodiment of the present disclosure, the recommendation system 106 minimizes the scoring function F1 based on a provided item from the one or more items. In yet another embodiment of the present disclosure, the recommendation system 106 predicts remaining items from the one or more items based on the provided item from the one or more items.

Extending the above stated example, the recommendation system 106 utilizes the type of content accessed by the user A (the new movie), B (the cricket match highlights) and C (news), the one or more type of devices used by the user A (laptop), the user B (smart phone) and the user C (television), the one or more channels accessed by the user A (youtube.com), the user B (star sports) and the user C (headlines today), the one or more time at which the user A (6 pm), the user B (8 pm) and the user C (10 am) view the content, the previous one or more advertisement skipping budgets provided by the user A (20$), the user B (10$ and 15$) and the user C (12$, 10$ and 30$), the advertisement skipping history corresponding to the user A (80%), the user B (60% and 50%) and the user C (90%, 70% and 80%) and the real time bidding amounts corresponding to the advertisement slots (as described above in the patent application). The recommendation system 106 recommends the user A to skip 80 percent of the one or more advertisements in the new movie with a budget of 0.23$ by watching the new movie on cbs.com at 8 pm, skip 70 percent of the one or more advertisements with a budget of 0.21$ by watching the new movie on hulu at 10 pm on his/her smart phone and to skip 80 percent of the one or more advertisements with a budget of 0.32$ by watching the new movie on nbc.com on his/her Roku. Further, the recommendation system 106 recommends the user B to skip 50 percent of the one or more advertisements with a budget of 0.22$ by watching the cricket match highlights on espn.com at 9 pm on his/her laptop and to skip 60 percent of the one or more advertisements with a budget of 0.26$ by watching the cricket match highlights on dailymotion at 9.15 pm on his/her Roku. Moreover, the recommendation system 106 recommends the user C to skip 90 percent of the one or more advertisements with a budget of 0.66$ by watching the news at 12 pm on his/her laptop, to skip 80 percent of the one or more advertisements with a budget of 0.58$ by watching the news on NDTV at 11 am on his/her Roku, to skip 60 percent of the one or more advertisements with a budget of 0.43$ by watching the news on CNN IBN at 11.30 am on his/her smart phone and to skip 70 percent of the one or more advertisements with a budget of 0.50$ by watching the news at 1 pm.

In an embodiment of the present disclosure, the recommendation system 106 recommends the one or more items such that the user 102 skips all the advertisements in the corresponding one or more advertisement slots in the content. For example, a user D accesses a video of a new episode of a popular reality show on his/her tablet on comedy central channel at 7.30 pm. The video includes four advertisement slots v1, v2, v3 and v4. The user D provided a budget of 15$ for skipping the one or more advertisements for first two months with an advertisement skipping percentage of 80 and a budget of 18$ for skipping the one or more advertisements in next three months with an advertisement skipping percentage of 90. The recommendation system 106 recommends the user D with a budget of 1.45$ for skipping 100 percent of the advertisements in the slots v1, v2, v3 and v4 if the user views the video of the reality show on www.cbs.com at 8 pm on his/her laptop.

In an embodiment of the present disclosure, the recommendation system 106 maintains a database for storing the profile corresponding to the user 102, the one or more previous advertisement skipping budgets corresponding to the user 102, the advertisement skipping history corresponding to the user 102, the type of content accessed by the user 102, the one or more type of devices used by the user 102, the one or more channels accessed by the user 102, the one or more time at which the user 102 watches the content and the one or more probabilistic amount provided to the user 102.

In another embodiment of the present disclosure, the advertisement skipping system 210 maintains the database corresponding to the user 102.

In yet another embodiment of the present disclosure, the method provides mobile applications with a SDK that supports both ad-supported free or one time paid platforms, thereby allowing the user 102 to watch/skip the advertisements with little amount of money.

In yet another embodiment of the present disclosure, the user 102 configures his/her choices through the account on the advertisement skipping system 210 associated with a television or a set top box via a physical remote.

In yet another embodiment of the present disclosure, the user 102 is provided with a button on the physical remote or in software settings of the set top box for directly skipping the advertisements while watching the content on his/her television set.

In yet another embodiment of the present disclosure, the user 102 can earn credits for watching the advertisement.

In yet another embodiment of the present disclosure, the advertisement skipping system 210 allows the user 102 to redeem the earned credits for skipping the optimum number of the one or more advertisements.

In yet another embodiment of the present disclosure, the user 102 redeems the earned credits for one or more services.

In yet another embodiment of the present disclosure, the user 102 earns the credits during the viewing of the advertisement after an each pre-defined interval. For example, a user Z is viewing an advertisement having a playtime of two minutes. The user Z earns credits after each 20 second intervals (say at 20 sec, 40 sec, and 60 sec). The user Z earns a fraction of the total credits to be earned after the finishing of the advertisement.

In yet another embodiment of the present disclosure, the user 102 earns the credits after watching the entire advertisement.

In yet another embodiment of the present disclosure, one or more devices (mobile and desktop) are equipped with rich media ad formats such as VPAID, MRAID and the like for overlaying an advertisement on top of an underlying advertisement. Further, the one or more users are given a choice to pay for skipping the advertisements or to view the underlying advertisement.

It may be noted that the recommendation system 106 recommends the one or more items to the user 102; however those skilled in the art would appreciate that the recommendation system 106 recommends the one or more items to more users. It may also be noted that the recommendation system 106 maintains the database corresponding to the user 102; however those skilled in the art would appreciate that the recommendation system 106 maintains the database corresponding to more users.

In an embodiment of the present disclosure, as illustrated in FIG. 2B, the recommendation system 106 is a part of the advertisement skipping system 210. In an embodiment of the present disclosure, the advertisement skipping system 210 illustrated in FIG. 2A and FIG. 2B may provide an advertisement skipping service which allows the one or more publishers 202, to offer users, such as user 102, an option to skip the optimum number of the one or more advertisements for a fee. In another embodiment of the present disclosure, the recommendation system 106 illustrated in FIG. 2A and FIG. 2B may provide a recommendation service which offers users, such as user 102 with one or more options such that to skip the optimum number of the one or more advertisements. Further, the recommendation system 210 recommends the one or more items to the user 102 for skipping the maximum percentage of the one or more advertisements in the corresponding one or more advertisement slots in the content.

In one embodiment of the present disclosure, the recommendation service provides the user 102 with choice and control, ease of use and a better advertisement viewingexperience. The recommendation service allows the user 102 to control his/her ad experience by skipping ads when desired, for a small fee per skip. As a result of not forcing the user 102 to view ads to support the production, licensing and distribution of the content, the recommendation service provides the user 102 with the better advertisement viewingexperience. If the user 102 wants to skip a particular advertisement, he/she can. And, if the user 102 wants to watch it, he/she can.

In order to skip the optimum number of the one or more advertisements, the user 102 must have an account (e.g., a secure digital wallet) with the advertisement skipping service (the advertisement skipping system 210) with a minimum level of funding (e.g., five dollars). In an embodiment of the present disclosure, the advertisement skipping service may accept multiple forms of payment to fund the account, such as electronic transfer (e.g., automated clearing house (ACH) transfer or wire transfer) from a designated bank account, credit card (e.g., Visa, MasterCard, Discover, American Express), online wallet (e.g., PayPal, Amazon Payments and Google Checkout) and/or mobile payment, digital currency and the like.

In an embodiment of the present disclosure, the user 102 may fund his/her secure digital wallet manually or by setting up auto-funding when the account falls below the minimum level of funding. The user 102 may be offered incentives to earn free skips or may be given coupons/discount to earn free skips. Free skips may be earned by user 102 for certain service milestones, e.g., signing up for an account, funding his/her account (e.g., one free skip for each dollar deposited over a minimum threshold), referrals and the like.

In another embodiment of the present disclosure, various tools can be used by a publisher of the one or publishers 202 to credit its advertisers of the one or more advertisers 206. In an embodiment of the present disclosure, the publisher of the one or publishers 202 is provided with access to a dashboard/user interface within the advertisement skipping service and the recommendation service. This dashboard allows the publisher of the one or publishers 202 to download a comprehensive report on all advertisements that were skipped and all the recommendations within a selectable date period or with any constraints. In an embodiment of the present disclosure, each of the one or more advertisers 206 may be provided with a corresponding dashboard/user interface. This corresponding dashboard/user interface may provide the one or more advertisers 206 with business intelligence reports related to the advertisement skipping services and the recommendation services.

The recommendation services and the advertisement skipping services not only help the user 102 with a better viewing experience but also allow the one or more publishers 202 to increase their available advertisement inventory. The recommendation service and the advertisement skipping service also allows the one or more publishers 202 to make more money by paying the one or more publishers 202 high CPMs for skipped advertisements. In addition, the advertisement skipping service and the recommendation service enhances relationships between the one or more publishers 202 and the one or more advertisers 206. The one or more advertisers 206 are credited for the skipped advertisements, thereby eliminating wasteful ad spending. In addition, by offering consumers a choice, the one or more publishers 202 offer a more engaging advertisement placement to the one or more advertisers 206, which increase the quality and relevancy of the publisher's advertisement inventory.

In an embodiment of the present disclosure, as illustrated in FIG. 2C, the recommendation system 106 is a part of the advertisement exchange 204. In another embodiment of the present disclosure, the advertisement exchange 204 illustrated in FIG. 2A, FIG. 2B and FIG. 2C may provide the recommendation service to the user 102 for recommending the one or more items such that the user 102 controls his/her ad viewing experience.

In yet another of the present disclosure, the advertisement exchange 204 facilitates the recommendation of the one or more items to the user 102. In yet another embodiment of the present disclosure, the recommendation system 106 facilitates the real time bidding process between the one or more publishers 202 and the one or more advertisers 206.

In yet another embodiment of the present disclosure, the recommendation system 106 calculates the one or more probabilistic amount based on the real time bidding amount of the one or more advertisement slots in the content calculated by the advertisement exchange 204.

In yet another embodiment of the present disclosure, the recommendation system 106 receives the information corresponding to the user 102 from the advertisement skipping system 210.

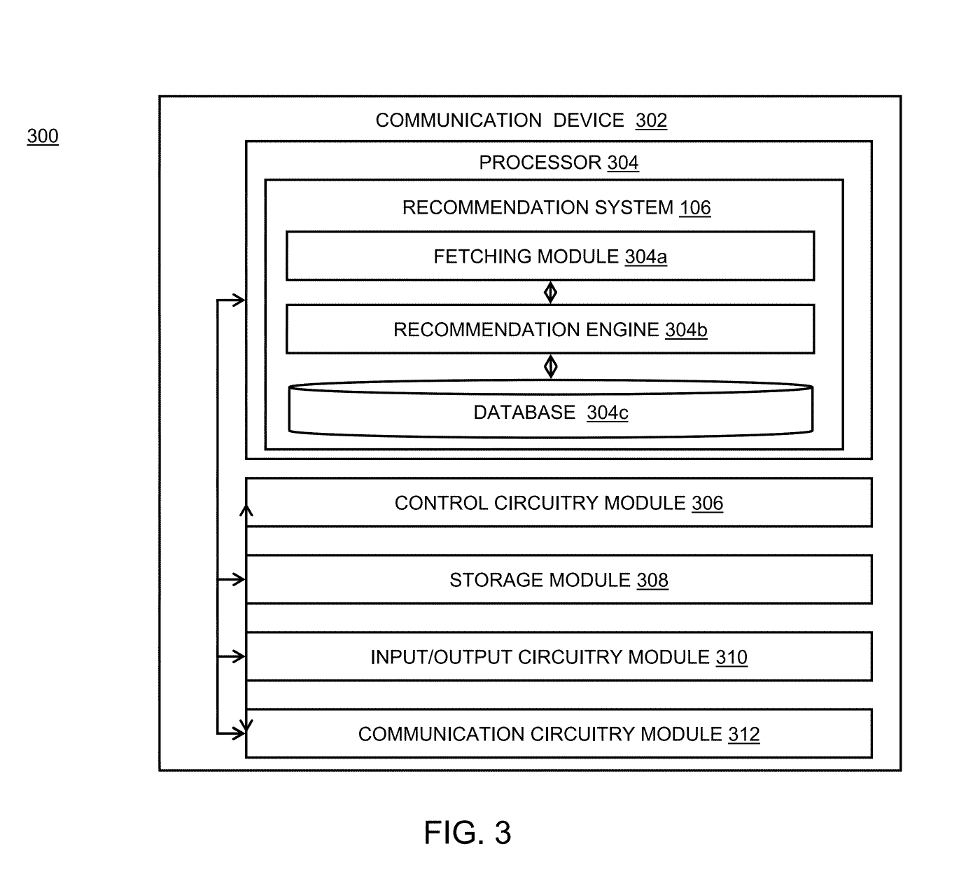

FIG. 3 illustrates a block diagram 300 of a communication device 302, in accordance with various embodiments of the present disclosure. The communication device 302 includes a processor 304, a control circuitry module 306, a storage module 308, an input/output circuitry module 310 and a communication circuitry module 312. Further, the processer 304 includes a fetching module 304a, a recommendation engine 304b and a database 304c. In an embodiment of the present disclosure, the processor 304 enables the working of the recommendation system 106 for recommending the one or more items to the user 102 for skipping the one or more advertisements at the corresponding one or more advertisement slots in the content. In another embodiment of the present of the disclosure, the communication device 302 enables the hosting of the recommendation system 106.

The fetching module 304a in the processor 304 fetches the first pre-determined set of attributes. The first pre-determined set of attributes includes the first set of parameters corresponding to the user 102 and the one or more pre-defined factors. Further, the one or more pre-defined factors are based on the pre-defined criterion. The first set of parameters includes the profile corresponding to the user 102. Moreover, the profile includes at least one of the gender of the user 102, the interaction of the user 102 with the one or more advertisements and the one or more choices of the user 102 corresponding to the type of the one or more advertisements. In addition, the pre-defined criterion is based on at least one of the type of content accessed by the user 102, the advertisement skipping history corresponding to the user 102 and the one or more previous advertisement skipping budgets corresponding to the user 102. In another embodiment of the present disclosure, the pre-defined criterion is based on at least one of the estimated amount for the one or more advertisement slots and the bid winning history corresponding to the user 102.

The recommendation engine 304b in the processor 304 recommends the one or more items to the user 102 for skipping the one or more advertisements in the corresponding one or more advertisement slots in the content. The one or more items includes at least one of the one or more probabilistic amount for skipping the one or more percentage of the one or more advertisements in the corresponding one or more advertisement slots in the content, the one or more channels to view the content on, the one or more type of devices to view content on and the one or more time for viewing the content.

The database 304c in the processor 304 stores the profile corresponding to the user 102, the one or more previous advertisement skipping budgets corresponding to the user 102, the advertisement skipping history corresponding to the user 102, the type of content accessed by the user 102, the one or more type of devices used by the user 102, the one or more channels accessed by the user 102, the one or more time at which the user 102 watches the content and the one or more probabilistic amount provided to the user 102.

It may be noted that in FIG. 3, various modules of the recommendation system 106 are shown that illustrates the working of the recommendation system 106; however those skilled in the art would appreciate that the recommendation system 106 may have more number of modules that could illustrate overall functioning of the recommendation system 106.

Going further, the communication device 302 includes any suitable type of portable electronic device. Examples of the communication device 302 include but may not be limited to a personal e-mail device (e.g., a Blackberry™ made available by Research in Motion of Waterloo, Ontario), a personal data assistant (“PDA”), a cellular telephone, a Smartphone, the laptop computer, and the tablet computer. In another embodiment of the present disclosure, the communication device 302 can be a desktop computer.

From the perspective of this disclosure, the control circuitry module 306 includes any processing circuitry or processor operative to control the operations and performance of the communication device 302. For example, the control circuitry module 306 may be used to run operating system applications, firmware applications, media playback applications, media editing applications, or any other application.

In an embodiment, the control circuitry module 306 drives a display and process inputs received from the user interface.

From the perspective of this disclosure, the storage module 308 includes one or more storage mediums including a hard-drive, solid state drive, flash memory, permanent memory such as ROM, any other suitable type of storage component, or any combination thereof. The storage module 308 may store, for example, media data (e.g., music and video files), application data (e.g., for implementing functions on the communication device 302).

From the perspective of this disclosure, the I/O circuitry module 310 may be operative to convert (and encode/decode, if necessary) analog signals and other signals into digital data. In an embodiment, the I/O circuitry module 310 may also convert the digital data into any other type of signal and vice-versa. For example, the I/O circuitry module 310 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 306, the storage module 308, or any other component of the communication device 302.

It may be noted that the I/O circuitry module 310 is illustrated in FIG. 3 as a single component of the communication device 302; however those skilled in the art would appreciate that several instances of the I/O circuitry module 310 may be included in the communication device 302.

The communication device 302 may include any suitable interface or component for allowing the user 102 to provide inputs to the I/O circuitry module 310. The communication device 302 may include any suitable input mechanism. Examples of the input mechanism include but may not be limited to a button, keypad, dial, a click wheel, and a touch screen. In an embodiment, the communication device 302 may include a capacitive sensing mechanism, or a multi-touch capacitive sensing mechanism.

In an embodiment, the communication device 302 may include specialized output circuitry associated with output devices such as, for example, one or more audio outputs. The audio output may include one or more speakers built into the communication device 302, or an audio component that may be remotely coupled to the communication device 302.

The one or more speakers can be mono speakers, stereo speakers, or a combination of both. The audio component can be a headset, headphones or ear buds that may be coupled to the communication device 302 with a wire or wirelessly.

In an embodiment, the I/O circuitry module 310 may include display circuitry for providing a display visible to the user 102. For example, the display circuitry may include a screen (e.g., an LCD screen) that is incorporated in the communication device 302.

The display circuitry may include a movable display or a projecting system for providing a display of content on a surface remote from the communication device 302 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 306. Alternatively, the display circuitry may be operative to provide instructions to a remote display.

In addition, the communication device 302 includes the communication circuitry module 312. The communication circuitry module 312 may include any suitable communication circuitry operative to connect to a communication network and to transmit communications (e.g., voice or data) from the communication device 302 to other devices within the communications network. The communication circuitry module 312 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communication circuitry module 312 may be operative to create a communications network using any suitable communications protocol. For example, the communication circuitry module 312 may create a short-range communication network using a short-range communications protocol to connect to other devices. For example, the communication circuitry module 312 may be operative to create a local communication network using the Bluetooth®, protocol to couple the communication device 302 with a Bluetooth®, headset.

It may be noted that the computing device is shown to have only one communication operation; however, those skilled in the art would appreciate that the communication device 302 may include one more instances of the communication circuitry module 312 for simultaneously performing several communication operations using different communication networks. For example, the communication device 302 may include a first instance of the communication circuitry module 312 for communicating over a cellular network, and a second instance of the communication circuitry module 312 for communicating over Wi-Fi or using Bluetooth®.

In an embodiment of the present disclosure, the same instance of the communications circuitry module 312 may be operative to provide for communications over several communication networks. In an embodiment, the communication device 302 may be coupled to a host device for data transfers, syncing the communication device 302, software or firmware updates, providing performance information to a remote source (e.g., providing riding characteristics to a remote server) or performing any other suitable operation that may require the communication device 302 to be coupled to the host device. Several computing devices may be coupled to a single host device using the host device as a server. Alternatively or additionally, the communication device 302 may be coupled to the several host devices (e.g., for each of the plurality of the host devices to serve as a backup for data stored in the communication device 302).

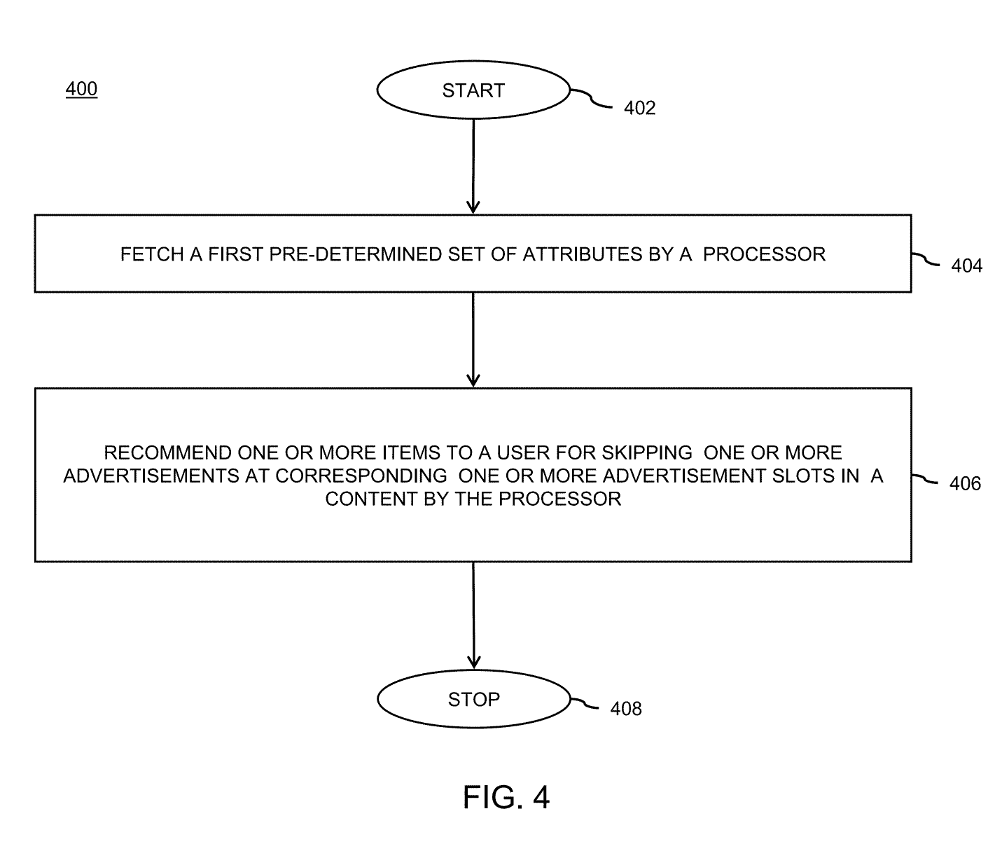

FIG. 4 illustrates a flowchart 400 for recommending the one or more items to the user 102 for skipping the one or more advertisements at the corresponding one or more advertisement slots in the content, in accordance with various embodiments of the present disclosure. It may be noted that to explain the process steps of FIG. 4, references will be made to the system elements of the FIG. 1, FIG. 2A, FIG. 2B, FIG. 2C and FIG. 3. The flow chart 400 initiates at step 402. Following step 402, at step 404, the fetching module 304a in the processor 304 fetches the first pre-determined set of attributes. At step 406, the recommendation engine 304b in the processor 304 recommends the one or more items to the user 102 for skipping the one or more advertisements at the corresponding one or more advertisement slots in the content. The flowchart terminates at step 408.

It may be noted that the flowchart 400 is explained to have above stated process steps; however, those skilled in the art would appreciate that the flowchart 400 may have more/less number of process steps which may enable all the above stated embodiments of the present disclosure.

What is claimed is:

1. A computer-implemented method for recommending one or more items to a user for skipping one or more advertisements at a corresponding one or more advertisement slots in a content, the computer-implemented method comprising:
fetching, with a processor, a first pre-determined set of attributes, wherein said first pre-determined set of attributes comprises a first set of parameters corresponding to said user and one or more pre-defined factors, wherein said one or more pre-defined factors being based on a pre-defined criterion; and
recommending, with said processor, said one or more items to said user for skipping said one or more advertisements at corresponding said one or more advertisement slots in said content,
wherein said one or more items comprises one or more probabilistic amount for skipping one or more percentage of advertisements at corresponding said one or more advertisement slots, one or more time for viewing said content, one or more channels for viewing said content and one or more type of devices for viewing said content,
wherein said one or more probabilistic amount being calculated based on said first set of parameters and said pre-defined criterion and wherein said recommendation of said one or more probabilistic amount to said user being based on calculation of a real time probable amount provided said user had viewed said one or more advertisements in said content.

2. The computer-implemented method as recited in claim 1, wherein said first set of parameters comprises a profile corresponding to said user, wherein said profile comprises at least one of gender of said user, interaction of said user with said one or more advertisements and one or more choices of said user corresponding to type of said one or more advertisements.

3. The computer-implemented method as recited in claim 1, wherein said pre-defined criterion being based on at least one of an estimated amount for said one or more advertisement slots and a bid winning history corresponding to said user.

4. The computer-implemented method as recited in claim 1, wherein said pre-defined criterion being based on at least one of type of said content, an advertisement skipping history corresponding to said user and one or more previous advertisement skipping budgets corresponding to said user.

5. The computer-implemented method as recited in claim 4, wherein said one or more previous advertisement skipping budgets being set by said user for skipping said one or more advertisements.

6. The computer-implemented method as recited in claim 1, wherein said calculation of said real time probable amount being based on a real time bidding process.

7. The computer-implemented method as recited in claim 1, further comprising maintaining, with said processor, a database of said first set of parameters, said advertisement skipping history, said one or more previous advertisement skipping budgets, said one or more probabilistic amount, said one or more time, said one or more channels and said one or more type of devices.

8. A computer program product comprising a non-transitory computer readable medium storing a computer readable program, wherein said computer readable program when executed on a computer causes said computer to perform steps comprising:
fetching a first pre-determined set of attributes, wherein said first pre-determined set of attributes comprises a first set of parameters corresponding to a user and one or more pre-defined factors, wherein said one or more pre-defined factors being based on a pre-defined criterion; and
recommending one or more items to said user for skipping one or more advertisements at corresponding one or more advertisement slots in a content,
wherein said one or more items comprises one or more probabilistic amount for skipping one or more percentage of advertisements at corresponding said one or more advertisement slots, one or more time for viewing said content, one or more channels for viewing said content and one or more type of devices for viewing said content,
wherein said one or more probabilistic amount being calculated based on said first set of parameters and said pre-defined criterion and wherein said recommendation of said one or more probabilistic amount to said user being based on calculation of a real time probable amount provided said user had viewed said one or more advertisements in said content.

9. The computer program product as recited in claim 8, wherein said first set of parameters comprises a profile corresponding to said user, wherein said profile comprises at least one of gender of said user, interaction of said user with said one or more advertisements and one or more choices of said user corresponding to type of said one or more advertisements.

10. The computer program product as recited in claim 8, wherein said pre-defined criterion being based on at least one of an estimated amount of said one or more advertisement slots and a bid winning history corresponding to said user.

11. The computer program product as recited in claim 8, wherein said pre-defined criterion being based on at least one of type of said content, an advertisement skipping history corresponding to said user and one or more previous advertisement skipping budgets corresponding to said user.

12. The computer program product as recited in claim 11, wherein said one or more previous advertisement skipping budgets being set by said user for skipping said one or more advertisements.

13. The computer program product as recited in claim 8, wherein said computer readable program when executed on said computer causes said computer to perform a step of maintaining a database of said first set of parameters, said advertisement skipping history, said one or more previous advertisement skipping budgets, said one or more probabilistic amount, said one or more time, said one or more channels and said one or more type of devices.

14. A system for recommending one or more items to a user for skipping one or more advertisements at a corresponding one or more advertisement slots in a content, the system comprising:
a fetching module in a processor being configured to fetch a first pre-determined set of attributes, wherein said first pre-determined set of attributes comprises a first set of parameters corresponding to said user and one or more pre-defined factors, wherein said one or more pre-defined factors being based on a pre-defined criterion; and
a recommendation engine in said processor and communicatively coupled to said fetching module, wherein said recommendation engine being configured to recommend said one or more items to said user for skipping said one or more advertisements at corresponding said one or more advertisement slots in said content,
wherein said one or more items comprises one or more probabilistic amount for skipping one or more percentage of advertisements at corresponding said one or more advertisement slots, one or more time for viewing said content, one or more channels for viewing said content and one or more type of devices for viewing said content,
wherein said one or more probabilistic amount being calculated based on said first set of parameters and said pre-defined criterion and wherein said recommendation of said one or more probabilistic amount to said user being based on calculation of a real time probable amount provided said user had viewed said one or more advertisements in said content.

15. The system as recited in claim 14, wherein said first set of parameters comprises a profile corresponding to said user, wherein said profile comprises at least one of gender of said user, interaction of said user with said one or more advertisements and one or more choices of said user corresponding to type of said one or more advertisements.

16. The system as recited in claim 14, wherein said pre-defined criterion being based on at least one of an estimated amount for said one or more advertisement slots and a bid winning history corresponding to said user.

17. The system as recited in claim 14, wherein said pre-defined criterion being based on at least one of type of said content, an advertisement skipping history corresponding to said user and one or more previous advertisement skipping budgets corresponding to said user.

18. The system as recited in claim 17, wherein said one or more previous advertisement skipping budgets being set by said user for skipping said one or more advertisements.

19. The system as recited in claim 14, wherein said calculation of said real time probable amount being based on a real time bidding process.

20. The system as recited in claim 14, further comprising a database in said processor being configured to maintain said database of said first set of parameters, said advertisement skipping history, said one or more previous advertisement skipping budgets, said one or more probabilistic amount, said one or more time, said one or more channels and said one or more type of devices.
